(19) United States
(12) Patent Application Publication
(10) Pub. No.: US 2001/0036853 A1
(43) Pub. Date: Nov. 1, 2001

(54) Systems and methods for presenting a lottery interface in an interactive wagering application

(75) Inventor: William L. Thomas, Bixby, OK (US)

Correspondence Address: FISH & NEAVE, 1251 AVENUE OF THE AMERICAS, 50TH FLOOR, NEW YORK, NY, 10020-1105, US

(73) Assignee: ODS Properties, Inc.

(21) Appl. No.: 09/809,922

(22) Filed: Mar. 16, 2001

Related U.S. Application Data
(60) Provisional application No. 60/194,801, filed on Apr. 5, 2000.

(51) Int. Cl. G06F 19/00

(52) U.S. Cl. 463/17

(57) ABSTRACT

Interactive wagering systems and methods are provided for giving a user the ability to participate in lotteries using user equipment. An interactive wagering application may provide the user with a listing of lotteries in which the user may participate. The user may select to participate in any one or more of the lotteries. The interactive wagering application may give the user the ability to automatically participate in lotteries using default lottery numbers or randomly generated lottery numbers. The interactive wagering application may provide notifications to the user when a lottery drawing is about to begin.

This application claims the benefit of U.S. provisional application Ser. No. 60/194,801, filed Apr. 5, 2000, which is hereby incorporated by reference herein in its entirety.

### BACKGROUND OF THE INVENTION

This invention relates to an interactive wagering service, and more particularly, this invention relates to an interactive wagering service having an interactive wagering application with a lottery interface feature.

Conventionally, lotteries are played by participants who must manually enter numbers on a form. The form must then be submitted, with payment, to an appropriate location, which requires the lottery participant to travel. In exchange for the payment, the participant receives a lottery ticket. This creates inconvenience for the participant because of the time and energy that must be expended to enter a lottery. In addition, when lotteries have relatively large jackpots, participants may be forced to spend an even greater amount of time waiting in line to purchase a lottery ticket.

Moreover, because the lottery ticket is the only proof that the participant has played a particular set of numbers, loss of the lottery ticket translates into a loss of any potential winnings.

Horse race wagering has been made more efficient by allowing participants to use their televisions to place wagers, rather than having to travel to a racetrack or other such establishment. This is shown by, for example, U.S. Pat. No. 5,830,068 (Brenner et al.).

It is therefore an object of the present invention to allow participants of a lottery to purchase lottery tickets in a more convenient and efficient manner.

### SUMMARY OF THE INVENTION

This and other objects of the present invention are accomplished by providing an interactive wagering application that gives a user the ability to participate in lotteries electronically using user equipment.

The interactive wagering application may provide the user with a listing of lotteries in which the user may legally participate. The user may be given the ability to participate in any one or more of these lotteries. The interactive wagering application may display, for each lottery, a customized display screen requesting any required information for participation in that particular lottery.

The interactive wagering application may record the lottery drawing of a particular lottery for the user. The interactive wagering application may remind the user when a particular lottery drawing is about to begin. The reminder may be communicated using any suitable notification, such as by a pop-up overlay on a television display, by email, by instant message, by an icon appearing on a display, by telephone, or by any other suitable notification.

The interactive wagering application may provide the user the ability to set default numbers, and any other required parameters, for one or more particular lotteries. The interactive wagering application may use the default numbers to automatically participate in the particular lotteries. In another suitable approach, the interactive wagering application may randomly generate numbers each time a lottery is played.

The interactive wagering application may participate in a particular lottery every time the lottery is offered. In another suitable approach, the participation may be based on conditions (e.g., time period elapsed since last participating, type of prize, odds, etc.).

The interactive wagering application may also provide the user with the ability to generate lottery gift certificates.

### BRIEF DESCRIPTION OF THE DRAWINGS

The above and other objects of the present invention will be apparent upon consideration of the following detailed description, taken in conjunction with the accompanying drawings, in which like reference characters refer to like parts throughout, and in which:

FIG. 1 is a schematic diagram of an illustrative interactive wagering system in accordance with one embodiment of the present invention;

FIG. 2 is a schematic diagram of illustrative user television equipment in accordance with one embodiment of the present invention;

FIG. 3 is a schematic diagram of additional illustrative user television equipment in accordance with one embodiment of the present invention;

FIG. 4 is a schematic diagram of illustrative user computer equipment in accordance with one embodiment of the present invention;

FIG. 5 is a diagram of an illustrative user cellular telephone equipment in accordance with one embodiment of the present invention;

FIG. 6 is a schematic diagram of illustrative user equipment in accordance with one embodiment of the present invention;

FIG. 7 shows an illustrative interactive wagering application display screen in which the user may select a lottery in accordance with one embodiment of the present invention;

FIG. 8 shows an illustrative interactive wagering application display screen in which the user may play a lottery in accordance with one embodiment of the present invention;

FIG. 9 is a flow chart of illustrative steps involved in providing the user with the ability to play a lottery in accordance with the one embodiment of the present invention;

FIG. 10 is a flow chart of illustrative steps involved in allowing the user to automatically participate in a lottery using default numbers in accordance with one embodiment of the present invention;

FIG. 11 is a flow chart of illustrative steps involved in allowing the user to participate in lotteries based on conditions in accordance with one embodiment of the present invention;

FIG. 12 shows an illustrative interactive wagering application display screen on which a reminder pop-up overlay window is displayed in accordance with one embodiment of the present invention;

FIG. 13 is a flow chart of illustrative steps involved in finalizing a lottery bet in accordance with one embodiment of the present invention;

FIG. 14A shows an illustrative interactive wagering application display screen with results for a lottery in accordance with one embodiment of the present invention;

FIG. 14B shows another illustrative interactive wagering application display screen with results for a lottery in accordance with one embodiment of the present invention;

FIG. 15 shows an illustrative interactive wagering application display screen that may provide the user with notification options in accordance with one embodiment of the present invention.

### DETAILED DESCRIPTION OF THE PREFERRED EMBODIMENTS

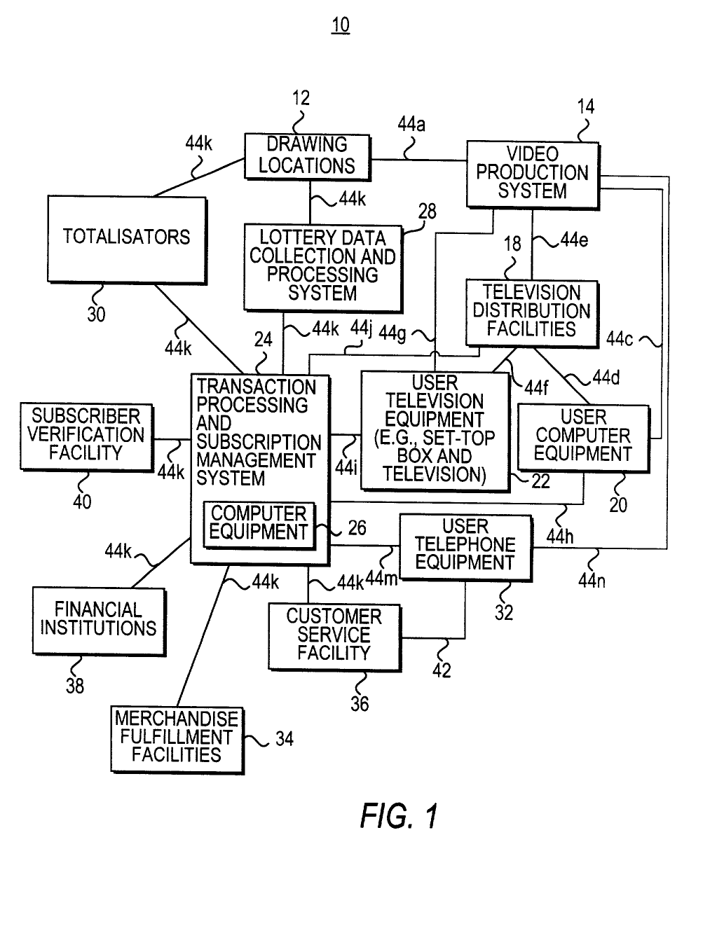

An illustrative interactive wagering system 10 in accordance with the present invention is shown in FIG. 1. Aspects of the invention apply to various different types of wagering, but are described herein primarily in the context of interactive wagering on lotteries (e.g., Pick-4, keno) for specificity and clarity.

Lottery drawings may be held at drawing location 12 that may be located at various geographic locations. Lottery drawings held at drawing locations 12 may be simulcast to television viewers. For example, simulcast videos may be provided to users with satellite receivers or to other suitable establishments via satellite.

Interactive wagering system 10 may be used to provide an interactive wagering service to users of various user equipment. An interactive wagering application may be used to provide users with the ability to use the interactive wagering service. In one suitable approach, the interactive wagering application may run locally on user equipment. User equipment may include a set-top box, a personal computer, a cellular telephone, a handheld computing device, or any other suitable device. In another suitable approach, the interactive wagering application may run using a client-server or distributed architecture where a portion of the interactive wagering application may be implemented locally on the user equipment in the form of, for example, a client process. Another portion of the interactive wagering application may be implemented at a remote location, such as on a server or any other suitable equipment as, for example, a server process. These arrangements are merely illustrative. Any other suitable arrangement for implementing the interactive wagering application may be used.

Real-time videos from drawing locations 12 may be provided to video production system 14 for distribution to users as part of an interactive television wagering service. For example, the videos may be provided via a wagering-related television channel, via an Internet-delivered service, or via any other suitable technique. In one suitable approach, multiple simulcast videos may be provided to video production system 14 in real-time.

In one suitable approach, video production system 14 or a separate facility may be used to reformat simulcasts from drawing locations 12. For example, if drawing locations 12 provide simulcasts as traditional analog television channels, video production system 14 (or a separate facility) may convert these simulcasts or portions of these simulcasts into digital signals (e.g., digital video signals) or into a different number of analog signals. Digital video signals may require less bandwidth than analog video signals and may be appropriate for situations in which videos are to be transmitted over either high or low bandwidth pathways. Low bandwidth pathways may include telephone lines, the Internet, or any other suitable pathway.

Video production system 14 may be used to provide an interactive television wagering service that may include selected simulcast videos, and graphic overlays to television distribution facilities 18 (for redistribution to user television equipment 22 and user computer equipment 20), to user computer equipment 20, and to user telephone equipment 32 (if user telephone equipment 32 has a display capable of displaying moving images). Television distribution facilities 18 may be any suitable facilities for supplying television to users, such as cable system headends, satellite systems, broadcast television systems, or other suitable systems or combinations of such systems. User computer equipment 20 may be any suitable computer equipment that supports an interactive wagering application. For example, user computer equipment 20 may be a personal computer. User computer equipment 20 may be based on a mainframe computer, a workstation, a networked computer or computers, a laptop computer, a notebook computer, a handheld computing device such as a personal digital assistant or other small portable computer, or any other suitable equipment.

Each of television distribution facilities 18 is typically located at a different geographic location. Users with user television equipment 22 may receive the interactive television wagering service from an associated television distribution facility. User television equipment 22 may include, for example, a television or other suitable monitor. A television may be used to watch the interactive television wagering service on a traditional analog television channel. User television equipment 22 may include a digital or analog set-top box connected to a television distribution facility 18 by, for example, a cable path. A digital set-top box may be used to receive the interactive television wagering service on a digital channel. In one suitable approach, user television equipment 22 may contain a satellite receiver, a WebTV® box, a personal computer television (PC/TV), or hardware similar to such devices into which set-top box capabilities have been integrated. A recording device such as a videocassette recorder or digital recording device (e.g., a personal video recorder (PVR) or digital video recorder (DVR) based on hard disk drives or the like) may be used in user television equipment 22 to store videos. The recording device may be separate from or part of the other components of user television equipment 22.

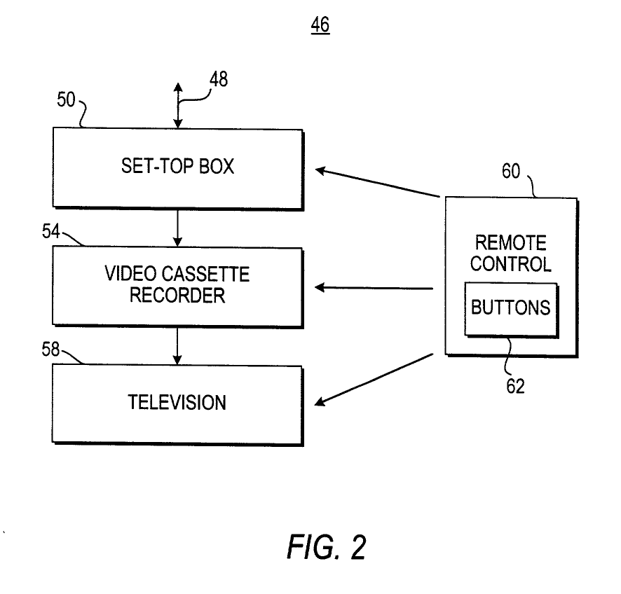

Illustrative user television equipment 46 is shown in FIG. 2. Set-top box 50 may receive television programming and data at input 48. Set-top box 50 may have analog and digital television tuning circuitry for handling analog and digital television signals. Television signals may be passed to videocassette recorder 54, that may be separate from the hardware (i.e., set-top box 50) that implements the interactive television wagering application, for recording. Set-top box 50 may control the operation of videocassette recorder 54. For example, set-top box 50 may issue infrared commands that are received by videocassette recorder 54 at the same inputs at which standard remote control commands are received.

Videocassette recorder 54 may be connected to television 58. Television programming and graphic display screens generated by applications implemented using set-top box 50 may be passed from set-top box 50 to television 58 through videocassette recorder 54.

Set-top box 50 may include memory and processing circuitry. This may allow set-top box 50 to be used to implement applications that support an interactive wagering application, interactive television wagering service, interactive television program guide, web browsing and Internet access, other services such as home shopping, home banking, and video-on-demand services, or any other suitable service.

A remote control 60 such as an infrared remote control may be used to control set-top box 50, videocassette recorder 54, and television 58. Remote control 60 may have buttons 62 such as a power button, right, left, up, and down arrow keys, an OK or select key, a favorites or fav key, a lock or parental control key, and any other suitable key.

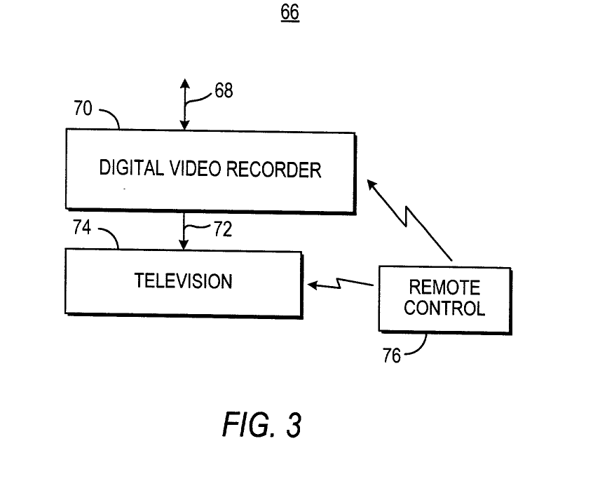

Illustrative user television equipment 66 based on a digital video recorder 70 is shown in FIG. 3. Digital video recorder 70 may receive television programming and may access interactive services using input 68. Digital video recorder 70 may have analog and digital tuning circuitry to receive and process television signals. Digital video recorder 70 may be used to record television programs in any suitable format. For example, digital videos may be stored using the MPEG-2 format.

Recorded videos or real-time videos from input 72 may be displayed on television 74 or any other suitable monitor. A remote control 76 such as an infrared remote control may be used to control digital video recorder 70 and television 74. Remote control 76 may have buttons such as a power button, right, left, up, and down arrow keys, an OK or select key, a favorites or fav key, a lock or parental control key, and any other suitable key.

Digital video recorder 70 has memory and processing circuitry that may allow digital video recorder 70 to be used to implement applications that support an interactive wagering application, interactive television wagering service, interactive television program guide, web browsing and Internet access, other services such as home shopping, home banking, and video-on-demand services, or any other suitable service. Television programming and display screens generated by interactive applications may be displayed on television 74.

Referring back to FIG. 1, user computer equipment 20 may receive the interactive television wagering service using a video card or any other suitable video-capable equipment to receive analog or digital (e.g., moving picture experts group or MPEG) videos from a television distribution facility 18. User computer equipment 20 may receive the interactive television wagering service directly from video production system 14 using, for example, a modem link. In one suitable approach, the video for the interactive television wagering service may be compressed, for example, using MPEG techniques. This may be useful, for example, if the path to user computer equipment 20 is a modem connection using telephone links. If video production system 14 is only used to serve user computer equipment 20 without traditional analog television capabilities, video production system 14 may only need to supply such digitally-compressed video signals and not analog television signals.

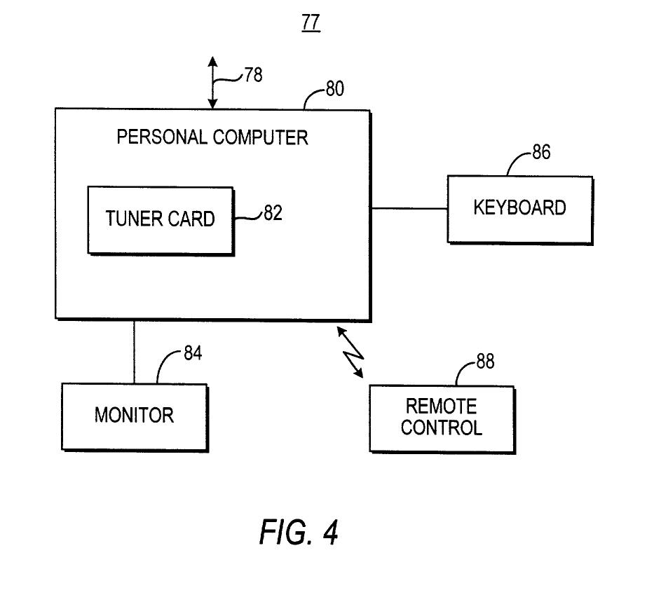

Illustrative user computer equipment 77 is shown in FIG. 4. User computer equipment 77 may be based on a personal computer 80 or any other suitable computing device. Personal computer 80 may receive television programing and information for interactive services using input 78. Personal computer 80 may contain a tuner card 82 or any other suitable circuitry for handling analog and digital television signals. Personal computer 80 may contain memory and processing circuitry that may allow personal computer 80 to be used to implement applications that support an interactive wagering application, interactive television wagering service, interactive television program guide, web browsing and Internet access, other services such as home shopping, home banking, video-on-demand services, or any other suitable service. Personal computer 80 may contain a storage device such as a hard disk drive to store videos. Television signals and screens generated by interactive applications may be displayed on monitor 84.

The user may interact with personal computer 80 using any suitable user input interface, such as keyboard 86, a pointing device such as a trackball, mouse, or touch pad, a voice recognition system, a handwriting recognition system, or any other suitable user input interface. In one suitable approach, the user may interact with personal computer 80 using a wireless remote control such as remote control 88. Remote control 88 may be, for example, an infrared remote control.

Referring back to FIG. 1, video clips of lottery drawings and other simulcast information may be provided to users in the form of an interactive television wagering service or by an interactive wagering service provided by the interactive wagering application. In one suitable approach, lottery-related videos may be provided to the user by using video production system 14 or any other suitable equipment to route appropriate video clips from the simulcasts to the user in real-time. Video clips may be stored for later viewing. For example, one or more video servers located at drawing locations 12, video production system 14, television distribution facilities 18, or at any other suitable location may be used to store video clips. The stored videos may then be played back in real-time or downloaded for viewing at user television equipment 22, user computer equipment 20, or user telephone equipment 32. The video clips may contain videos of lottery drawings, commentary, interviews with jackpot winners, or any other suitable lottery-related information. In one suitable approach, real-time or stored videos may be provided from drawing locations 12 directly to user television equipment 22, user computer equipment 20, or user telephone equipment 32 over the Internet or via any other suitable communications paths without involving video production system 14. Videos may be provided by routing video signals through equipment located elsewhere in interactive wagering system 10. For example, videos may be routed through transaction processing and subscription management system 24.

Transaction processing and subscription management system 24 may contain computer equipment 26 and other equipment for supporting system functions such as transaction processing (e.g., handling tasks related to wagers, product purchasing, adjusting the amount of funds in user accounts based on the outcomes of wagers, video clip ordering, or any other suitable task), data distribution (e.g., for distributing lottery data to the users), and subscriber management (e.g., features related to opening an account for a user, closing an account, allowing a user to add or withdraw funds from an account, changing the user's address or personal identification number, or any other suitable feature). Databases within transaction processing and subscription management system 24 or associated with system 24 may be used to store lottery data, wagering data and other transaction data, and subscriber data such as information on the user's current account balance, past wagering history, individual wager limits, personal identification number, billing addresses, credit card numbers, bank account numbers, social security numbers, or any other suitable information. Using such databases may allow the user to access information more quickly and may allow for central administration of the interactive wagering service.

In one suitable approach, totalisators 30 may be used for processing odds and payoff amounts related to paramutual-based lotteries.

In one suitable approach, lottery drawing videos and other services may be provided using servers and other equipment located at transaction processing and subscription management system 24. For example, video clips may be provided to the user on-demand. Interactive advertisements may be provided to the user. When the user selects a desired advertisement, transaction processing and subscription management system 24 may provide additional information or other services related to the advertisement to the user.

Product ordering services may be implemented using computer equipment 26 at transaction processing and subscriber management system 24 to handle orders and to assist in adjusting the appropriate account of the user accordingly. Orders may be fulfilled using merchandise fulfillment facilities 34. Merchandise fulfillment facilities 34 may be operated solely to provide merchandise fulfillment or may be associated with independently-operated mail-order or on-line businesses. Similar facilities may be used to allow users to order services.

Statistical lottery data such as the drawing times for each lottery, type of lottery, location of lottery, or any other suitable information, may be provided by lottery data collection and processing system 28. Some of the data may be collected from drawing locations 12 and some may be provided by third party information sources.

Transaction processing and subscription management system 24 may provide the lottery data to users at user television equipment 22, user computer equipment 20, and user telephone equipment 32 for use in following lottery results and developing wagers. In one suitable approach, lottery data may be provided to users using paths that do not directly involve transaction processing and subscription management system 24. For example, lottery data may be provided from lottery data collection and processing system 28 to user television equipment 22, user computer equipment 20, or user telephone equipment 32 using the Internet or other suitable communications paths.

User telephone equipment 32 may be a conventional telephone, a cordless telephone, a cellular telephone or other portable wireless telephone, or any other suitable telephone equipment. Users at user television equipment 22 and user computer equipment 20 may view information on the lottery data on a television or other suitable monitor. Users at user telephone equipment 32 may listen to lottery data using an interactive voice system. User telephone equipment 32 may be based on cellular telephones with displays. Users may view lottery data displayed on such displays.

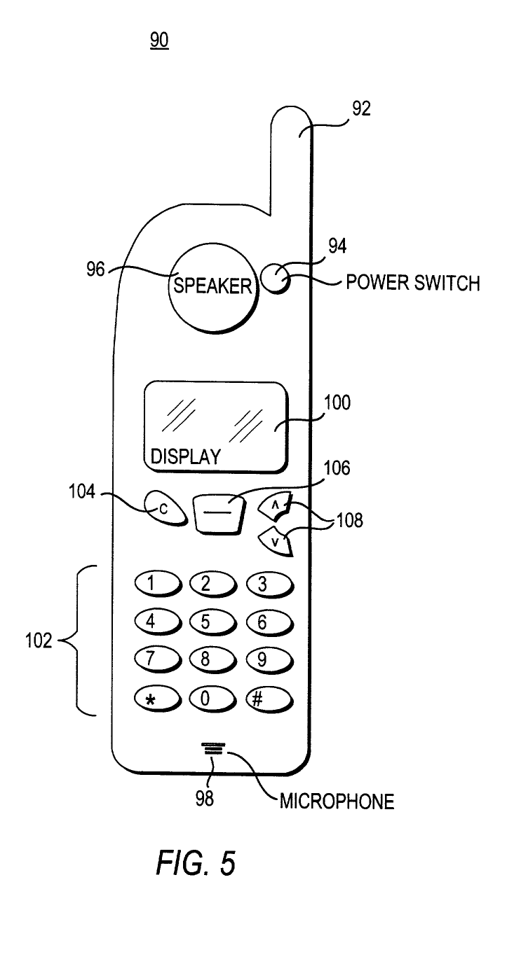

An illustrative cellular telephone 90 with which the user may use the interactive wagering application is shown in FIG. 5. A portion of the software that is used to implement the interactive wagering service may be resident on cellular telephone 90. Cellular telephone 90 may have a recording device for storing software instructions and videos. Cellular telephone 90 may also have a processor for executing the instructions and displaying the videos.

Cellular telephone 90 may have an antenna 92 to support wireless communications with transaction processing and subscription management system 24, customer service facility 36, or video production system 14, as shown in FIG. 1. A power switch 94 may be used to turn cellular telephone 90 on and off. A speaker 96 may allow the user to listen to conversations and to listen to audio prompts from, for example, transaction processing and subscription management system 24, as shown in FIG. 1. A microphone 98 may allow the user to converse with others. Display 100 may be a liquid crystal display (black and white or color), a plasma display, a light-emitting diode display, an active matrix display, or any other suitable type of small display screen. Keys 102 may allow the user to enter inputs. Numeric keys 102, including the star and pound key, may allow the user to respond to interactive voice response system prompts, such as “press 3 to select lottery 3,” and may allow the user to enter numbers to select numerically identified on-screen menu options and the like that are displayed on display 100. In one suitable approach, some of the numeric keys 102 may perform secondary functions if, for example, they are pressed and held for at least a predetermined length of time. Clear key 104 may be used to clear characters from display 100. If the user presses and holds clear key 104, the user may be taken back to the initial screen displayed on display 100 upon power up. Navigation key 106 may be used to access menus, make telephone calls, or perform any other suitable function. Scroll keys 108 may be used to scroll through menus and to scroll through other items presented on display screen 100.

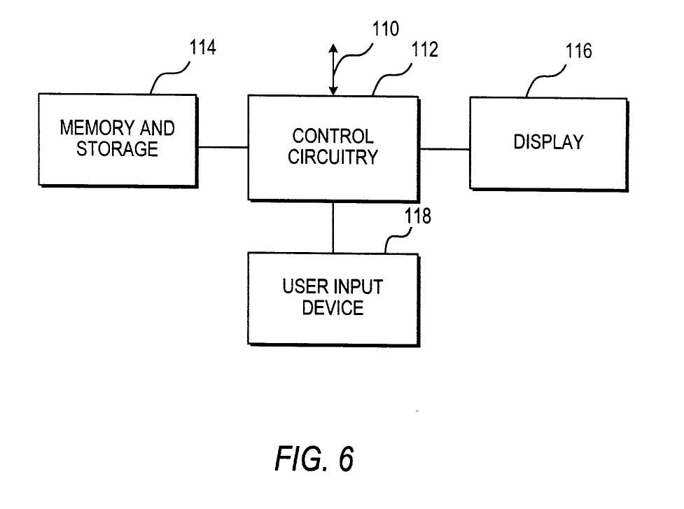

A generalized schematic diagram of user equipment, such as user television equipment 22, user computer equipment 20, and user telephone equipment 32 of FIG. 1, is shown in FIG. 6. Control circuitry 112 and memory and storage 114 may have communications, memory, and processing circuitry suitable for supporting functions such as receiving television programming, recording videos in storage, and accessing interactive services over line 110. Line 110 may be coupled to communications paths such as paths 42, 44c, 44d, 44f-i, 44m, and 44n of FIG. 1. Television programming and text, graphics, and video associated with interactive services may be presented to the user using display 116. Display 116 may be a television, a computer monitor, or any other suitable display equipment.

The user may interact with control circuitry 112 using any suitable user input device 118, such as a remote control, a keyboard, a wireless keyboard, a display remote, a handheld computer, a mouse, a trackball, a touch pad, or any other suitable input device.

Referring back to FIG. 1, users who wish to place wagers may establish an account at transaction processing and subscription management system 24. An account may be established at one of totalisators 30. The user and the interactive wagering services provider may have their own bank accounts at financial institutions 38. A user may set up an account electronically by using user television equipment 22, user computer equipment 20, or user telephone equipment 32 to interact with the subscriber management functions of transaction processing and subscription management system 24. In another suitable approach, accounts may be established with the interactive wagering service with the assistance of customer service representatives at customer service facility 36. Customer service facility 36 may be at the same location as transaction processing and subscription management system 24, may be a part of system 24, or may be located remote from system 24. Customer service representatives at customer service facility 36 may be reached by telephone. If user telephone equipment 32 is used to access the interactive wagering service, for example, user telephone equipment 32 may be used to reach the customer service representative using communications path 42. If user television equipment 22 or user computer equipment 20 is being used with the interactive wagering service, a telephone at the same location as that equipment may be used to reach the customer service representative.

The user's identity may be checked using social security number information or other identification information with the assistance of subscriber verification facility 40. The services of subscriber verification facility 40 are used to ensure that the user lives in a geographic area in which wagering is legal, that the user is of a legal age, and that the identification information, for example, the user's social security number, matches the name provided by the user. If the user is using a cellular telephone or handheld computing device, the user's present physical location may be determined by determining which general part of the cellular telephone network is being accessed by the user. In another suitable approach, the user's present physical location may be determined by using the cellular network or a handset-based location device, such as a global positioning system (GPS) receiver in the body of the cellular telephone, to pinpoint the user's location. This location information may be used to verify that the user is located in a geographic area where wagering is legal.

In a typical enrollment process, the user may provide personal information to the interactive wagering service and provide funds with a credit card or funds from the user's bank account. The interactive wagering service may set up an account for the user at transaction processing and subscription management system 24 and may direct one of totalisators 30 to set up a new account for the user at the totalisator. The totalisator may be directed to credit the user's account to reflect the amount of funds provided by the user. After the user places a wager and wins or loses, the totalisator may adjust the user's totalisator account to reflect the outcome of the wager. The totalisator may periodically inform the interactive wagering service of the adjusted balance in the user's account. This may be accomplished using any suitable technique, for example, periodically, continuously, on-request, or by any other suitable technique. In one suitable approach, reports may be collected periodically, for example, once a day in an end-of-day report, and provided to the interactive wagering service to reconcile the account balances at transaction processing and subscription management system 24 with the account balances at totalisators 30.

If the user makes a balance inquiry, the inquiry may be passed to the appropriate totalisator by transaction processing and subscription management system 24. If the user is charged a fee for subscribing to the service, the service may debit the fee from the user's account at the transaction processing and subscription management system 24.

The accounts at totalisators 30 and transaction processing and subscription management system 24 may be maintained separately because the business entities that operate totalisators 30 and transaction processing and subscription management system 24 are independent. In one suitable approach, financial functions related to opening and maintaining user accounts and the like may be handled using computer equipment at another location, such as one of financial institutions 38 or any other suitable location remote from totalisators 30 and transaction processing and subscription management system 24. In another suitable approach, such financial functions may be implemented primarily at a totalisator 30 or primarily at the transaction processing and subscription management system 24.

Users at user television equipment 22, user computer equipment 20, and user telephone equipment 32 may place wagers by providing wagering data and by otherwise interacting with transaction processing and subscription management system 24. The interactive wagering service may provide a user at user television equipment 22, user computer equipment 20, or user telephone equipment 32 that has display capabilities with screens containing various lottery data. For example, the user may be presented with screens that allow the user to view the current odds for an upcoming lottery.

The interactive wagering service may provide the user with interactive screens containing menus and selectable options that allow the user to specify the type of wager in which the user is interested and the desired wager amount. With a set-top box arrangement, for example, the user may use a remote control or wireless keyboard to navigate the various menus and selectable options. With a personal computer, the user may use a keyboard, mouse, trackball, touch pad, or other suitable input or pointing device. With a cellular telephone with a display, the user may use buttons on the telephone. When the user has made appropriate selections to define a desired wager, user television equipment 22, user computer equipment 20, or user telephone equipment 32 may transmit wagering data for the wager to transaction processing and subscription management system 24.

Users with telephones may interact with the interactive wagering service using an interactive voice response system located at transaction processing and subscription management system 24. The interactive voice response system may present menu options to the user in the form of audio prompts, for example, “press 1 to select a $2 wager amount” or any other suitable audio prompt. The user may interact with the interactive wagering service by pressing the corresponding buttons on a touch tone telephone. User telephone equipment 32 that is based on cellular telephones may allow the user to interact with the interactive wagering service in this way. User telephone equipment 32 that is based on cellular telephones with messaging and display capabilities may allow the user to interact visually with the interactive wagering service.

The components of interactive wagering system 10 may be interconnected using various communications paths 44. Communications paths 44 may include satellite paths, coaxial cable paths, fiber-optic paths, twisted pair paths, other wire or cable-based links, wireless paths through free space, or any other suitable paths or combination of such paths. Communications over paths 44 may involve analog transmissions, digital transmissions, wireless transmissions, microwave transmissions, radio-frequency transmissions, optical transmissions, audio transmissions, or any other suitable type of transmissions or combination of such transmissions. Communications may involve Internet transmissions, private network transmissions, packet-based transmissions, television channel transmissions, transmissions in the vertical blanking interval (VBI) of a television channel or on a television sideband, MPEG transmissions, or any other suitable type of transmissions. Communications may involve wireless pager or other messaging transmissions. Communications paths 44 may include cable connected to cable modems, digital subscriber lines, integrated services digital network (ISDN) lines, or any other suitable paths. Examples of suitable communications paths are described below. Those examples are merely illustrative. Any of the communications path arrangements described above or other suitable arrangements may be used.

Communications paths that carry video and particularly uncompressed analog video, lightly-compressed digital video, or full-screen digital video generally use more bandwidth than communications paths that carry only data or that carry partial-screen digital video. For example, to transmit high-quality simulcasts of lottery drawings from drawing locations 12 to video production system 14, analog or digital videos may be transmitted from drawing locations 12 to video production system 14 over path 44a using satellite links. Videos may be transmitted from video production system 14 to user computer equipment 20 over path 44c using a modem link that uses, for example, a digital subscriber line, a telephone network link, a wireless link, or any other suitable link. The modem link may be made over a private network.

A user with a cable modem may connect a personal computer or other such user computer equipment 20 to an associated cable system headend using, for example, path 44d. The headend in such an arrangement would be one of the television distribution facilities 18 shown in FIG. 1. The user may then receive videos from the headend via cable modem. Videos may be provided to the headend over path 44e using a network link, fiber optic links, cable links, microwave links, satellite links, or any other suitable link. A user with a set-top box or similar device, shown in FIG. 1 as user television equipment 22, may receive videos from a cable system headend using a cable modem or other such communications device over path 44f. A user with user television equipment 22 may receive videos over the Internet or a private network using a telephone-based modem or other such communications device using path 44g. In a system with distributed processing, interactive wagering services may be provided using a television distribution facility 18 that includes equipment that supplements or replaces at least some of the equipment at transaction processing and subscription management system 24.

In one suitable approach, user television equipment 22 or user computer equipment 20 may receive analog or digital videos from an associated television distribution facility over the communications paths normally used to distribute television programming, such as paths 44f and 44d, respectively. For example, videos may be received as part of a dedicated interactive wagering service television channel. If videos are provided as digital signals, for example, as MPEG signals, 10 or more digital videos may be carried on a single analog channel. In another suitable approach, one digital video may be carried on one-tenth of the bandwidth of an analog channel. If the videos are not full-screen videos, even more videos may be simultaneously provided without a loss of image quality.

Lottery drawing videos may be provided to user telephone equipment 32 over a telephone Internet link or any other suitable telephone link using path 44n.

In one suitable approach, lottery data may accompany the lottery drawing videos along any of these paths. Lottery drawing videos may be provided by routing them directly from drawing locations 12 to user television equipment 22, user computer equipment 20 (e.g., over the Internet or a private network, or any other suitable network), or user telephone equipment 32. Lottery drawing videos may be provided by routing them through transaction processing and subscription management system 24. If a cellular telephone, such as cellular telephone 90, or portable computing device has sufficient display capabilities to support moving images, lottery drawing videos may be displayed. Such videos may be provided using any suitable path, such as a direct path from drawing locations 12, a path through video production system 14 or other suitable video processing equipment, through a hub such as transaction processing and subscription management system 24, or through any other suitable path. Lottery drawing videos may be provided in real-time or may be recorded for later distribution. In another suitable approach, videos that are not provided in real-time may be downloaded by user television equipment 22, user computer equipment 20, a cellular telephone, or any other suitable user equipment at a lower data rate than would otherwise be required and may be downloaded in the background. Such videos may be provided to the user at real-time video rates for direct viewing by the user.

Lottery data and other information related to the interactive wagering service may be provided to users over paths connected to transaction processing and subscription management system 24. For example, lottery data and other data for the interactive wagering service may be provided to user computer equipment 20 over path 44h using a modem link. Path 44h may be a private network path or an Internet path. Path 44h may use telephone lines, digital subscriber lines, ISDN lines, wireless data paths, or any other suitable type of communications links. User television equipment 22 may receive data for the interactive wagering service over communications path 44i, that may be a telephone line, digital subscriber line, ISDN line, or any other suitable type of communications path and which may use a private network path, an Internet path, or any other suitable path.

Data for the interactive wagering service may be provided to users of the interactive wagering application via communications path 44j and paths 44f and 44d. Communications path 44j may be provided over a private network, over a public telephone network, over satellite links, or over any other suitable type of links. In one suitable approach, data from paths such as path 44j may be routed to paths such as paths 44f and 44d, directly by associated television distribution facilities 18. In another suitable approach, the data may be buffered at television distribution facilities 18. Paths 44f and 44d, may include coaxial cable, and use of paths 44f and 44d, may involve the use of cable modems or the like. If data is provided over path 44j and paths 44f or 44d, using an Internet protocol, a web browser or similar software running on user television equipment 22 or user computer equipment 20 may be used to access the data. Such software may be integrated into the interactive wagering application or may be used separately. In another suitable approach, software may be used to view videos and may be used on other platforms, for example, advanced cellular telephones.

The communications paths 44k that are used to connect various other components of interactive wagering system 10 typically do not carry high-bandwidth video signals. Accordingly, paths 44k may be telephone-like paths that are part of the Internet or a private network. Such paths and various other paths 44 may be dedicated connections for security, reliability, and economy.

User telephone equipment 32 may receive information for the interactive wagering service via path 44m. If user telephone equipment 32 is a standard (non-cellular) telephone, such information may be in the form of audio prompts, such “press 1 to place a wager,” and audio lottery data, such as “the current jackpot for the New York lottery is five million dollars.” Transaction data processing and subscription management system 24 may contain interactive voice response equipment that provides such information to the user and that responds to touch-tone signals from the user when the user responds to prompts by pressing buttons on the user's telephone.

If user telephone equipment 32 is a cellular telephone, lottery data and other information for the interactive wagering service may be provided to the user by using a cellular wireless connection as part of path 44m. Users with cellular telephones may be provided with audio prompts using an interactive voice response system located at transaction processing and subscription management system 24 to which the users may respond by pressing cellular telephone buttons to generate touch-tone signals.

Lottery data and other information for the interactive wagering service may be provided to cellular telephones in the form of alphanumeric messages. Such messages may be transmitted to the user by using paging or other alphanumeric messaging formats or any other suitable data communications scheme. In one suitable approach, data may be provided to the cellular telephones over the voice channel and decoded by the cellular telephone using modem circuitry or other suitable circuitry. Data may be provided using any other suitable cellular or wireless path. Regardless of the way in which lottery data and other information for the interactive wagering service are provided to the cellular telephone, such information may be provided to the user by displaying it on the cellular telephone display screen or by presenting it in audible form through the speaker of the cellular telephone.

Lottery data and other interactive wagering service information for the users may be provided in one or more continuous data streams, may be provided periodically (e.g., once per hour or once per day), or may be provided using a client-server arrangement in which data is requested by a client processor (e.g., user television equipment 22, user computer equipment 20, user telephone equipment 32, or any other such equipment) from a server (e.g., a server implemented using computer equipment 26 at transaction processing and subscription management system 24 or computer equipment at another suitable location). Videos may be provided using any of these techniques.

A return communications path between the user and the interactive wagering service may be used to allow the user to place wagers and otherwise interact with the interactive wagering service. For example, a user with a standard telephone or a cellular telephone may interact with the interactive wagering service by pressing touch-tone keys on the telephone in response to audio prompts provided by an interactive voice response system at transaction processing and subscription management system 24. In one suitable approach, users may call customer service representatives at customer service facility 36 and place wagers with manual assistance. The user of a cellular telephone may interact with the interactive wagering service by selecting menu options and otherwise interacting with information displayed on the cellular telephone. When a selection is made, software implemented on the telephone may be used to assist the user in transmitting appropriate data, for example, wagering data, to the interactive wagering service. Such data may be transmitted using any suitable technique. For example, data may be transmitted using a wireless data link that is separate from the cellular voice channels. Data may be transmitted over the voice channel, for example, by using a modem built into the cellular telephone, by automatically generating touch-tone signals that may be recognized by the interactive voice response system at transaction processing and subscription management system 24, or using any other suitable arrangement. These approaches may be used even if the user receives lottery data and other information for the interactive wagering service using a platform other than a telephone-based platform.

Users with user television equipment 22 may interact with the interactive wagering service by sending data, such as wager data, to transaction processing and subscription management system 24 using path 44i or using paths 44f and 44j. Users with user computer equipment 20 may send data, such as wager data, to transaction processing and subscription management system 24 via path 44h or paths 44d, and 44j. Users at any user equipment may send data for the interactive wagering service to locations other than transaction processing and subscription management system 24. For example, the user may provide information directly to customer service facility 36, or any other suitable location.

In one suitable approach, interactive wagering system 10 may send data to the interactive wagering service at transaction processing and subscription management system 24 using different paths than those used to receive data from transaction processing and subscription management system 24. For example, lottery data may be received at user television equipment 22 via paths 44j and 44f, whereas data may be sent by interactive wagering system 10 from user television equipment 22 to transaction processing and subscription management system 24 using path 44i, or any other suitable path. The paths used to receive certain video information may be different from those used to receive lottery data. For example, user television equipment 22 may receive lottery drawing videos using path 44f, but may receive lottery data using path 44i. These examples are merely illustrative. Any suitable combination of paths may be used to distribute lottery data and other information for the interactive wagering service, any suitable combination of paths may be used to receive videos, and any suitable combination of paths may be used to send data to the interactive wagering service.

In one suitable approach, the user may be given the ability to interact with the interactive wagering service using more than one platform. For example, the user may be given the ability to place a wager using a cellular telephone while the user is driving home. When the user arrives home, the user may determine the outcome of the wager by watching a video of the lottery drawing on user television equipment. Later in the day, the interactive wagering application may provide the user with the ability to check the user's account balance using a personal computer. This is merely an illustrative example. The various wagering platforms may be used in any suitable combination.

Interactive wagering system 10 has been described in the context of a system that supports multiple wagering platforms. In another suitable approach, interactive wagering system 10 may support fewer platforms. For example, aspects of the invention may be implemented using an interactive wagering system 10 that only supports cellular telephone wagering or wagering using handheld computer devices. In one suitable approach, interactive wagering system 10 may be configured so that it does not support personal computer wagering, wagering with standard telephones, or wagering with user television equipment. The system may support cellular telephones and/or handheld computing devices such as personal digital assistants, palm-sized computers, or any other suitable computing device, in combination with any other suitable platform.

The features of the present invention are sometimes described herein in the context of an interactive wagering application implemented on user television equipment. This is only illustrative. An interactive wagering application implemented on any suitable platform (e.g., user computer equipment, user telephone equipment, or any other suitable platform) may be used to provide such features. In computer arrangements, on-screen options may be selected by clicking on them using a mouse pointer or other pointing arrangement. In set-top box arrangements, on-screen options may be made larger than they appear in computer-based arrangements to accommodate the greater viewing distance from which televisions are typically operated. Options may be selected by highlighting them using remote control arrow keys and by pressing an appropriate key such as an OK or enter or select key. In cellular telephone arrangements and handheld computer arrangements, options and information may be displayed using smaller screens than are typically available on personal computer or set-top box arrangements. To accommodate the smaller screen size, options that might otherwise be presented on a single screen may be displayed using multiple screens or layered menus. Options may be selected by highlighting them using navigation keys and pressing an appropriate select button on the cellular telephone or handheld computing device or by using a pen-based interface or the like.

The interactive wagering application may be implemented using application software that runs primarily on user television equipment, user computer equipment, user telephone equipment, or other local platform or using a remote server or other computer that is accessed from the local platform. Arrangements in which interactive wagering services are implemented using software on remote computers that is accessed on-demand from local platforms may be referred to as client-server arrangements. Such client-server arrangements may be used to allow client processes on set-top boxes or other platforms to access server processes running on servers located at cable system headends or other television distribution facilities 18, as shown in FIG. 1. Regardless of the type of system architecture or platform used, the software that supports the interactive wagering service features described herein may be referred to as an interactive wagering application.

In a set-top box environment, the interactive wagering system may allow the user to launch the interactive wagering application by selecting a menu option in an interactive television program guide or other set-top box application or menu. In one suitable approach, the interactive wagering application may be launched automatically whenever the user tunes to a particular channel, for example, the wagering-related television channel. After the user has tuned to this channel, the interactive wagering system may display an interactive icon on the user's television screen that indicates that the interactive wagering application is available. If the user presses an “OK” remote control key, the interactive wagering system may launch the interactive wagering application.

In a computer-based system, the user may access the interactive wagering application by browsing to an Internet web site or a site on a private network.

Interactive wagering systems based on cellular telephones or the like may be launched by selecting an appropriate on-screen menu option presented on the display of the cellular telephone.

Interactive wagering system 10 is shown to be compatible with various forms of user equipment (e.g., computers, telephones, television equipment, etc.). For purposes of brevity and clarity, and not by way of limitation, the interactive wagering application of the present invention is primarily described herein in conjunction with the use of user television equipment 22. It should be understood that this is merely an illustrative embodiment of the present invention, and that any other suitable user equipment or combination of user equipment may be used.

The interactive wagering application of the present invention, when implemented on user television equipment, may be incorporated into an interactive television application, such as a program guide. Such an interactive television application is described in Ellis et al. U.S. patent application Ser. No. 09/346,134, filed Jul. 16, 1999, which is hereby incorporated by reference herein in its entirety. It should be understood that the features of the interactive wagering application, as described herein, may be performed by the interactive television application. For example, in one suitable approach, the interactive wagering application may be used to display display screens. In another suitable approach, the interactive television application may be responsible for displaying display screens. For purposes of brevity and clarity, and not by way of limitation, the present invention is primarily described herein as using the interactive wagering application to perform all of the functions of the present invention.

The interactive wagering application of the present invention may provide a user with an interface having suitable display screens that may be used by the user to participate in any suitable and legal form of lottery. For example, the interactive wagering application may provide the user with the ability to participate in states lotteries, federal lotteries, keno, municipal lotteries, or any other suitable and legal form of lottery.

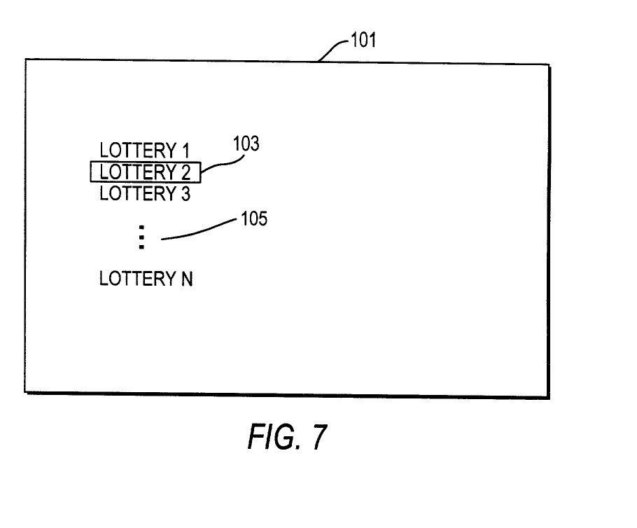

FIG. 7 shows an illustrative display screen 101 that may be displayed by the interactive wagering application that may allow the user to select any available lottery 105. Lotteries 105 may include any suitable and legal lottery in which the user may participate. The list of lotteries 105 may, for example, be partly based on the user's location. For example, if a particular state lottery (in the case of the United States) is only allowed to be played within the state with which the lottery is associated, then only users who are using user television equipment 22 within that state may be provided with the ability to select that particular lottery. Municipal lotteries may, likewise, be limited to their associated municipalities. National lotteries may be available for selection by anyone in the associated nation. If the law allows, national, state, and municipal lotteries may be played internationally, between different states, and between different municipalities, respectively.

Display screen 101 may also provide the user with proprietary lottery selections, such as a casino's or a hotel's proprietary keno game. For example, user television equipment 22 may be in a hotel room where the user may access the hotel's keno games, or any other suitable lotteries, via the interactive wagering application. Any such proprietary lottery may be offered to the user.

To select a lottery 105, the user may use a remote control or any other suitable device to move a highlight region 103 over a lottery 105 in which the user wishes to participate. Once highlight region 105 is over the desired lottery, the user may press a “select” button, or any other suitable button, on the remote control. This is merely an illustrative way in which the user may select a lottery 105. Any other suitable way may be used.

Display screen 101 is merely an illustrative arrangement of elements that may be displayed to the user for lottery selection. Any other suitable arrangement may be used. In one suitable approach, other suitable options and features may be integrated into display screen 101.

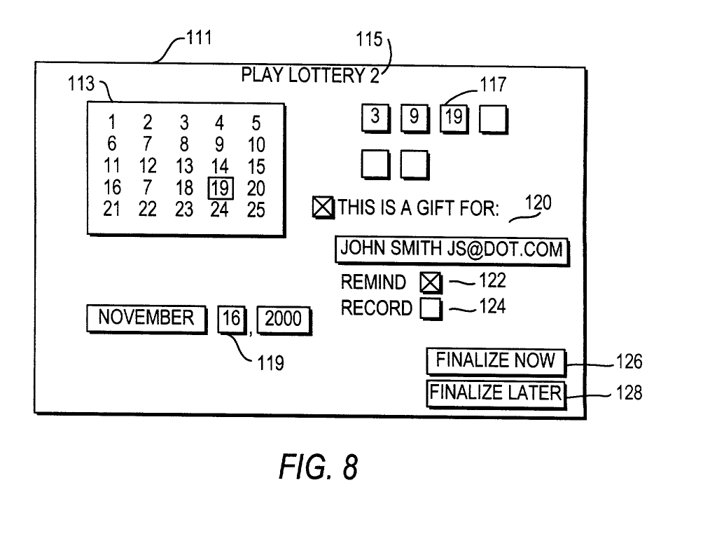

FIG. 8 shows an illustrative display screen 111 that may be displayed by the interactive wagering application to provide the user with the ability to play a particular lottery 115. The interactive wagering application may provide number selection region 113 to allow the user to select which numbers to play for lottery 115. Lottery selection region 113 may be customized by the interactive wagering application for each particular lottery 115. For example, if a particular lottery has a choice of numbers from “1” to “25,” then the interactive wagering application may display numbers “1” to “25” in number selection region 113.

Number chosen region 117 may be displayed in display screen 111. Number chosen region 117 may indicate to the user the currently selected numbers to be played in lottery 115. The interactive wagering application may limit the number of numbers that are chosen by the user (i.e., displayed in number chosen region 117) based on the number of numbers that are required to be chosen for lottery 115. In one suitable approach, the interactive wagering application may take into account that fact that some lotteries (e.g., keno) may have a variable number of numbers that may be chosen by the user.

When lottery 115 is offered more than one time, such as on a periodic basis, date entry region 119 may be displayed to the user. Date entry region 119 may provide the user with the ability to choose one or more dates to play lottery 115. The interactive wagering application may limit the user to choosing only dates on which lottery 115 is offered.

Display screen 111 is merely illustrative. Any other suitable customized arrangement may be used. For example, if a particular lottery requires certain additional information (e.g., supplemental numbers, letters, words, times, etc.) then the interactive wagering application may provide the user with the ability to enter the additional information. In one suitable approach, the interactive wagering application may require the user to enter all essential information before the interactive wagering application processes the bet.

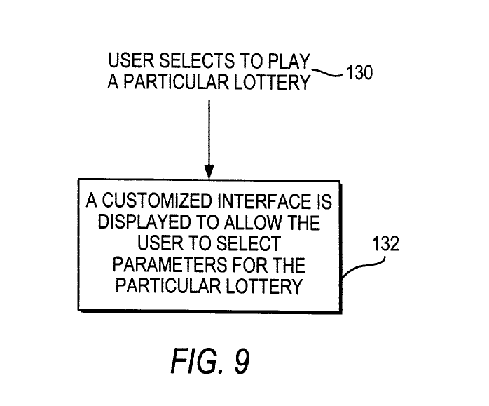

FIG. 9 is a flow chart of illustrative steps involved in providing the user with the ability to play a lottery. At step 130 the user may select to play a particular lottery, by, for example, selecting a lottery from the list of lotteries 105 of FIG. 7. At step 132, the interactive wagering application may provide to the user a customized interface for the particular lottery the user selected to play. The customized interface, such as display screen 111 of FIG. 8, may allow the user to choose parameters (e.g., numbers to play) for the selected lottery. This is a generalized flow chart. Any other suitable steps may be taken in addition to those illustrated.

In one suitable embodiment of the interactive wagering application of the present invention, the interactive wagering application may provide the user with the ability to specify a default set of numbers for particular lotteries. For example, for a four-number lottery, the user may save four suitable numbers that may be used by the interactive wagering application as the default numbers to play for that particular lottery. In one suitable approach, the interactive wagering application may automatically participate in the lottery, on the user's behalf, every time that lottery is offered. The interactive wagering application may use the default numbers that the user previously specified.

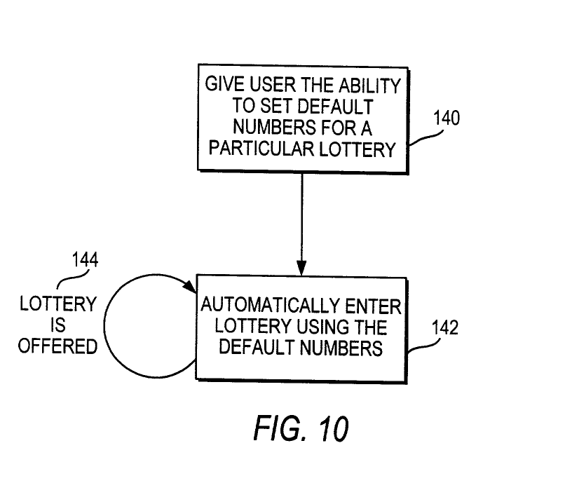

FIG. 10 is a flow chart of illustrative steps involved in allowing the user to automatically participate in a lottery using default numbers. At step 140, the interactive wagering application may provide the user with the ability to set default numbers (and any other required information) for a particular lottery. At step 142, the interactive wagering application automatically enters the lottery, on behalf of the user, using the default numbers chosen by the user at step 140. In one suitable approach, the interactive wagering application may enter the lottery, on behalf of the user, every time the lottery is offered (step 144). In another suitable approach, the user may be given the ability to specify whether to participate in the lottery more than once or when to participate in the lottery using the default numbers.

In another suitable approach, the interactive wagering application may provide the user with the ability to use a random number generator to produce the numbers to be played for a particular lottery. In another suitable approach, the default numbers may be determined using a random number generator. Any such suitable use of randomness may be used.

In another suitable embodiment of the interactive wagering application of the present invention, the interactive wagering application may provide the user with the ability to set conditions on whether to play a lottery. Any suitable conditions may be set by the user. For example, suitable conditions may include the amount of or type of lottery prize, a certain amount of time having passed since last participating in a lottery, odds of winning, or any other suitable conditions.

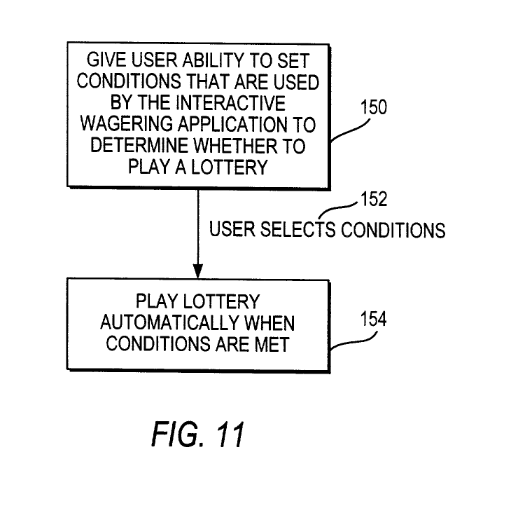

FIG. 11 is a flow chart of illustrative steps involved in allowing the user to participate in lotteries based on conditions that the user may set. At step 150, the interactive wagering application may provide the user with the ability to set conditions that are to be used by the interactive wagering application to determine whether to participate in a lottery on behalf of the user. At step 152, the user may select and set conditions to be used. At step 154 the interactive wagering application may automatically participate in a lottery if all of the user's specified conditions are met.

In one suitable embodiment of the interactive wagering application of the present invention, the interactive wagering application may allow the user to create a lottery bet, but before the lottery bet is entered, the user may need to finalize or confirm the bet. Referring back to FIG. 8, the user may finalize the lottery at the time of creating the bet, such as by selecting finalize now option 126. Alternatively, the user may create a bet, but choose to finalize it later, such as by selecting finalize later option 128. When the bet is created, it may be stored in any suitable location using interactive wagering system 10. When the bet is finalized, the user's account may be debited for the appropriate amount of money for participating in that particular lottery.

In one suitable approach, when the user creates a bet, but does not finalize the bet, the interactive wagering application may remind the user of the unfinalized bet at any suitable time before the time of the lottery. The reminder may take any suitable form. For example, the reminder may be an overlay window that may pop up on the user's display when the user is watching a television program, or when the user is otherwise using the features of the interactive television application or the interactive wagering application. The reminder may be in any other suitable form, such as an icon that may be part of an on-screen interface, an e-mail message, an instant message, a telephone message, a beeper page, or any other suitable form of a reminder.

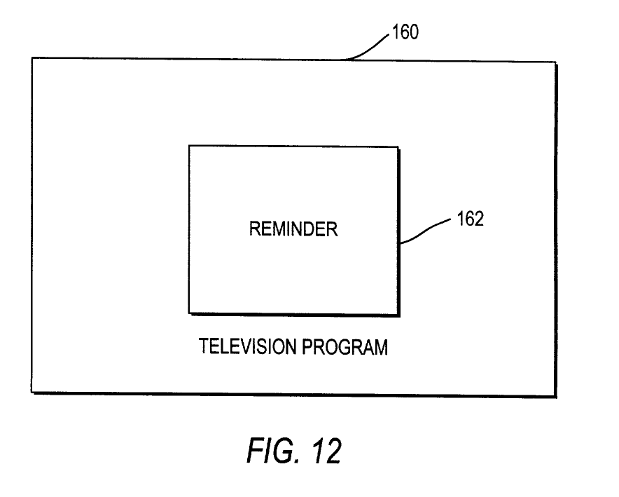

FIG. 12 shows an illustrative display screen 160 on which a reminder pop-up overlay window 162 is displayed. Pop-up overlay window may include any suitable reminder, such as a reminder to finalize a lottery bet. This is merely an illustrative way in which to use a pop-up overlay window to provide the user with a reminder. Any other suitable use of an overlay may be implemented. Any other suitable reminder may be used.

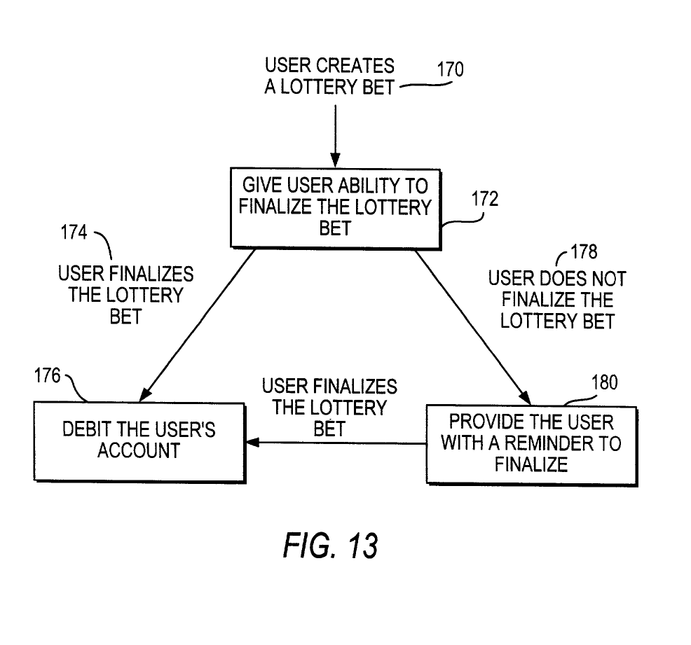

FIG. 13 is a flow chart of illustrative steps involved in finalizing a lottery bet. At step 170, a user may create a lottery bet. In response thereto, the interactive wagering application may provide the user with the ability to finalize the lottery bet at step 172. If the user finalized the lottery bet at step 174, then at step 176, the interactive wagering application may debit the user's account and may enter the user into the lottery drawing. If the user does not finalize the lottery bet at step 178, then at step 180 the interactive wagering application may provide the user with a reminder to finalize at some suitable point prior to the lottery drawing. If the user finalizes the lottery at this point, then step 176 may be performed. If the user never finalizes the lottery bet, and the lottery drawing takes place, the lottery bet may be deleted, ignored, or both.

The interactive wagering application may also provide the user with the ability to make any desired changes to the bet before the bet is finalized.

The interactive wagering application of the present invention may provide the user with the ability to view any available lottery drawing. For example, the user may view lottery drawings in which the user is participating. Referring back to FIG. 8, the interactive television application may provide the user with the ability to remind the user about an upcoming lottery drawing, using, for example, remind option 122. The reminder may take any suitable form. For example, the reminder may take any of the forms previously mentioned for finalization reminders. The reminder may provide the user with a link to the television channel on which the lottery drawing will be taking place.

In another suitable approach, the interactive wagering application may provide the user with the ability to schedule a recording of the lottery drawing, using, for example, record option 124. If the user chooses to record the lottery drawing, then the lottery drawing, assuming it is broadcasted, may be recorded using any suitable recording technique. For example, the lottery drawing may be recorded using a videocassette recorder, a digital television recorder, a personal computer having sufficient storage space, or any other suitable recording device.

After a lottery drawing has taken place, the interactive wagering application may provide the user with the ability to view the results of the lottery drawing. For example, the user may access a list of all lottery drawings that have taken place for a particular period of time. This list may be similar in nature to the list of lotteries 105 of FIG. 7. The user may select any past lottery to view the results of the lottery. If the user participated in the lottery, then the results may also indicate to the user whether the user has won any prize. If the user has won something, then the winnings may be described (e.g., amount of money, description of prize, etc.).

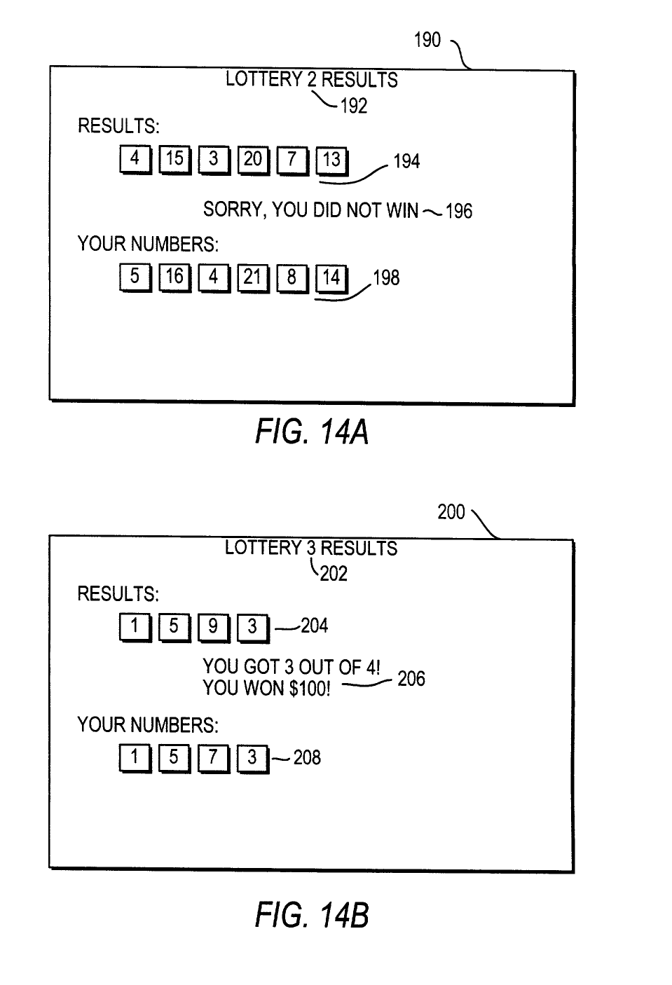

FIG. 14A shows an illustrative display screen 190 including results 194 for a particular lottery 192 in which the user participated. A message 196 may be generated by the interactive wagering application to indicate to the user that the user did not win any prize. The user may also be shown numbers 198 that were played in lottery 192 on the user's behalf. FIG. 14B shows another illustrative display screen 200 including results 204 for a particular lottery 202 in which the user participated. A message 206 may be generated by the interactive wagering application to indicate to the user that the user matched enough numbers to win a prize of $100. The user may also be shown numbers 208 that were played in lottery 202 on the user's behalf.

Display screens 190 and 200 are merely illustrative. Any other suitable arrangement may be used to indicate to the user the results of a lottery. For example, if the user accesses the results of a lottery in which the user did not participate, then information, such as message 196 and numbers played 198, may not be displayed.

In another suitable approach, the user may be notified of lottery results via any suitable notification. For example, the result may be displayed in a pop-up overlay at the conclusion of the lottery drawing in a manner similar to the way reminder 162 is presented in FIG. 7. Results may also be sent to the user via an e-mail, via a telephone (e.g., a cellular telephone with Internet functionality, voice mail, etc.), via a pager, via an instant message, or via any other suitable communication technique.

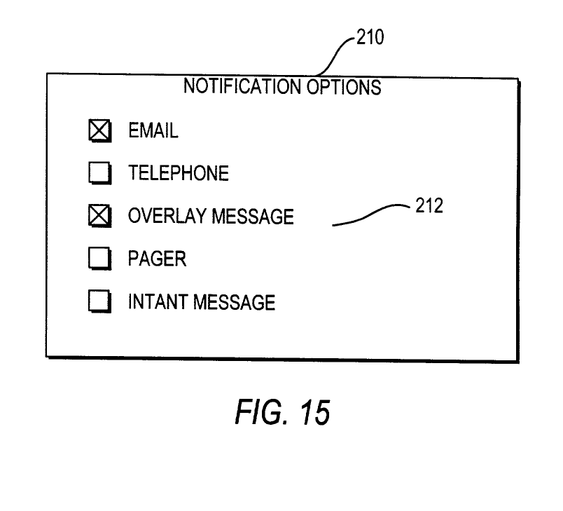

The interactive wagering application may provide the user with the ability to determine how the user is to receive lottery results. FIG. 15 shows an illustrative display screen 210 that may provide the user with notification options 212.

In one suitable embodiment of the present invention, the interactive wagering application may provide the user with the ability to purchase lottery gift certificates for other people. Referring back to FIG. 8, the user may use gift certificate option 120 to purchase a lottery gift certificate for another person. In one suitable approach, the lottery gift certificate may be an electronic lottery ticket for which the user has selected the numbers. In another suitable approach, the lottery gift certificate may be an electronic voucher with which the recipient of the gift certificate may participate in any available lottery (i.e., assuming the amount of the gift certificate is enough to cover the participation cost).

If the recipient of the gift certificate is not a user of system 10, the interactive wagering application, or both, then the recipient may be notified of his or her gift via any suitable communication. For example, the recipient may be notified via an e-mail, via a cellular telephone (e.g., with Internet functionality), via a pager, via an instant message, or via any other suitable communication technique. The recipient may also be notified automatically of the result of the lottery via any of these communication techniques.

If the recipient of the gift certificate is a user of system 10, the interactive wagering application, or both, then in addition to the communication techniques just mentioned, the recipient may also receive a notification via, for example, a pop-up overlay or any other suitable on-screen indicator.

Thus, systems and methods for presenting a lottery interface in an interactive wagering application are provided. One skilled in the art will realize that the present invention can be practiced by other than the described embodiments, which are presented for purposes of illustration and not of limitation, and that the present invention is limited only by the claims which follow.

What is claimed is:

1. A method for using an interactive wagering application to allow a user to participate in lottery wagering using user equipment, comprising:
providing a listing of lotteries in which the user can participate on a display; and
giving the user the ability to participate in at least one of the lotteries using the user equipment.

2. The method of claim 1 further comprising notifying the user that results to at least one of the lotteries in which the user participated are available.

3. The method of claim 2 wherein the notification is selected from a group consisting of a pop-up overlay, an icon, an e-mail, an instant message, a pager message, a telephone message, and any combination thereof.

4. The method of claim 1 further comprising displaying the results to at least one of the lotteries in which the user participated.

5. The method of claim 4 further comprising indicating whether the user won for each of the lotteries for which results are displayed.

6. The method of claim 1 further comprising recording the lottery drawings associated with the lotteries in which the user participated.

7. The method of claim 1 further comprising reminding the user of an upcoming lottery drawing associated with at least one of the lotteries in which the user participated.

8. The method of claim 1 further comprising giving the user the ability to generate a lottery gift certificate.

9. The method of claim 1 further comprising displaying a user interface to the user to use in creating a wager for at least one of the lotteries, wherein the user interface is customized for each one of the lotteries.

10. The method of claim 1 further comprising:
creating a wager based on user inputs;
giving the user the ability to finalize the wager at a later time; and
reminding the user to finalize the wager.

11. An interactive wagering system for using an interactive wagering application to allow a user to participate in lottery wagering using user television equipment, comprising user equipment configured to:
provide a listing of lotteries in which the user can participate on a display; and
give the user the ability to participate in at least one of the lotteries using the user television equipment.

12. The system of claim 11 further comprising user equipment configured to notify the user that results to at least one of the lotteries in which the user participated are available.

13. The system of claim 12 wherein the notification is selected from a group consisting of a pop-up overlay, an icon, an e-mail, an instant message, a pager message, a telephone message, and any combination thereof.

14. The system of claim 11 further comprising user equipment configured to display the results to at least one of the lotteries in which the user participated.

15. The system of claim 14 further comprising user equipment configured to indicate whether the user won for each of the lotteries for which results are displayed.

16. The system of claim 11 further comprising user equipment configured to record the lottery drawings associated with the lotteries in which the user participated.

17. The system of claim 11 further comprising user equipment configured to remind the user of an upcoming lottery drawing associated with at least one of the lotteries in which the user participated.

18. The system of claim 11 further comprising user equipment configured to give the user the ability to generate a lottery gift certificate.

19. The system of claim 11 further comprising user equipment configured to display a user interface to the user to use in creating a wager for at least one of the lotteries, wherein the user interface is customized for each one of the lotteries.

20. The system of claim 11 further comprising user equipment configured to:
create a wager based on user inputs;
give the user the ability to finalize the wager at a later time; and
remind the user to finalize the wager.

21. A method for using an interactive wagering application to allow a user to participate in a lottery automatically using user equipment, comprising:
giving the user the ability to set conditions; and
automatically participating in the lottery on behalf of the user when the conditions have been met.

22. The method of claim 21 wherein automatically participating in the lottery comprises using a default set of lottery numbers.

23. The method of claim 22 wherein the default set of lottery numbers are user-specified.

24. The method of claim 21 wherein automatically participating in the lottery comprises using a set of randomly generated lottery numbers.

25. The method of claim 21 wherein the conditions are based on factors selected from the group consisting of a period of time from the last time the user participated in the lottery, the lottery prize, odds of winning, and any combination thereof.

26. The method of claim 21 further comprising automatically participating in the lottery on behalf of the user every time the lottery is offered.

27. A system for using an interactive wagering application to allow a user to participate in a lottery automatically comprising user equipment configured to:
give the user the ability to set conditions; and
automatically participate in the lottery on behalf of the user when the conditions have been met.

28. The system of claim 27 further comprising user equipment configured to use a default set of lottery numbers when automatically participating in the lottery.

29. The system of claim 28 wherein the default set of lottery numbers are user-specified.

30. The system of claim 27 further comprising user equipment configured to use a set of randomly generated lottery numbers when automatically participating in the lottery.

31. The system of claim 27 wherein the conditions are based on factors selected from the group consisting of a period of time from the last time the user participated in the lottery, the lottery prize, odds of winning, and any combination thereof.

32. The system of claim 27 further comprising user equipment configured to automatically participate in the lottery on behalf of the user every time the lottery is offered.
